(19) United States
(12) Patent Application Publication
(10) Pub. No.: US 2022/0279693 A1
(43) Pub. Date: Sep. 8, 2022

(54) SHOVEL HEAD

(71) Applicant: Active Products International Limited, (US)

(72) Inventors: James HOU, Toronto (CA); James Derek CASEY, Shanghai (CN); John MACKIN, San Diego, CA (US); Roy JIA, Shanghai (CN)

(21) Appl. No.: 17/192,723

(22) Filed: Mar. 4, 2021

(51) Int. Cl. A01B 1/02

(52) U.S. Cl. CPC A01B 1/024

(57) ABSTRACT

There is provided a shovel head of a shovel. The shovel head affixable to a shaft of the shovel, the shovel head including: an elongated socket for receiving the shaft therein at a receiving end; a blade connected to the socket opposite the receiving end; and one or two steps extending rearwards from the top of the blade. In a particular case, the shovel head includes exactly two steps and each step is located on opposite sides of the connection to the elongated socket.

### TECHNICAL FIELD

The following relates generally to shovels, and more specifically, to a shovel head.

### BACKGROUND

Shovels are hand tools used to perform a variety of useful tasks, such as digging in the ground or soil, and lifting and moving of bulk materials.

### SUMMARY

In an embodiment, there is provided a shovel head of a shovel, the shovel head affixable to a shaft of the shovel, the shovel head comprising: an elongated socket for receiving the shaft therein at a receiving end, the socket forming one or more structural ribs, the one or more structural ribs being approximately parallel to the length of the elongated socket; and a blade connected to the socket opposite the receiving end.

In a particular case, the one or more structural ribs comprise folds in the elongated socket.

In another case, the one or more structural ribs are located on a front side of the elongated socket.

In yet another case, the one or more structural ribs extend into a neck of the elongated socket.

In yet another case, the one or more structural ribs extend from approximately the receiving end of the elongated socket and terminate where the elongated socket connects to the blade.

In yet another case, the one or more structural ribs comprises exactly three structural ribs.

In another embodiment, there is provided a shovel head of a shovel, the shovel head affixable to a shaft of the shovel, the shovel head comprising: an elongated socket for receiving the shaft therein at a receiving end; a blade connected to the socket opposite the receiving end; and one or two steps extending rearwards from the top of the blade.

In a particular case, there are exactly two steps and each step is located on opposite sides of the connection to the elongated socket.

In another case, the one or two steps are formed out of the blade.

In yet another case, the one or two steps are affixed to the blade.

In yet another case, the one or two steps comprise one or more ridges formed out of each respective step.

In yet another case, the one or more ridges are formed where the respective step meet the blade.

In yet another case, the one or more ridges are formed out of both the blade and the respective step.

These and other aspects are contemplated and described herein. It will be appreciated that the foregoing summary sets out representative aspects of the embodiments to assist skilled readers in understanding the following detailed description.

### DESCRIPTION OF THE DRAWINGS

A greater understanding of the embodiments will be had with reference to the Figures, in which:

FIG. 1 illustrates a front elevation view of a shovel with a shovel head, according to an embodiment;

FIG. 2 illustrates a front perspective view of the shovel head of FIG. 1;

FIG. 3 illustrates a rotated top-down perspective view of the shovel head with a partial cutaway of a shaft of the shovel head of FIG. 1;

FIG. 4 illustrates a top-down perspective view of the shovel head of FIG. 1;

FIG. 5 illustrates a perspective partial cutaway view along the shaft of the shovel head of FIG. 1;

FIG. 6 illustrates a side elevation view of the shovel head of FIG. 1;

FIG. 7 illustrates a rear elevation view of the shovel head of FIG. 1; and

FIG. 8 illustrates a bottom-up perspective view of the shovel head of FIG. 1.

### DETAILED DESCRIPTION

Embodiments will now be described with reference to the figures. For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practised without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

The following relates generally to shovels, and more specifically, to a shovel head. Illustrative embodiments of the shovel head disclosed herein will now be described in detail with reference to the figures.

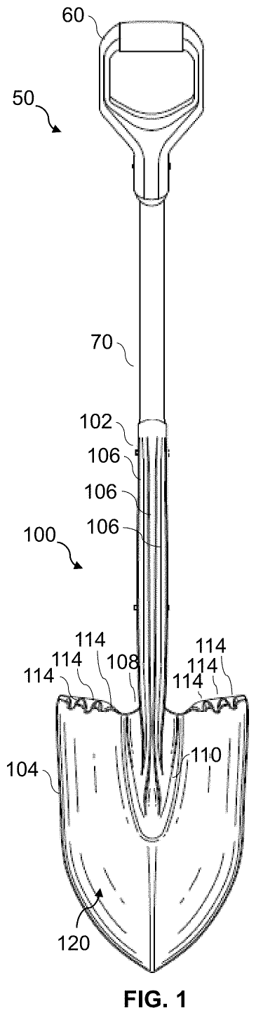

FIG. 1 illustrates a front view of a shovel 50. The shovel 50 comprises a handle 60 mounted on a shaft 70. The handle 60 and the shaft 70 can be made of any suitable material; for example hard-woods, hard plastic, glass-reinforced plastic (ex., fibreglass), or metal. The handle 60 can have any suitable shape to allow grasping of the top of the shovel 50.

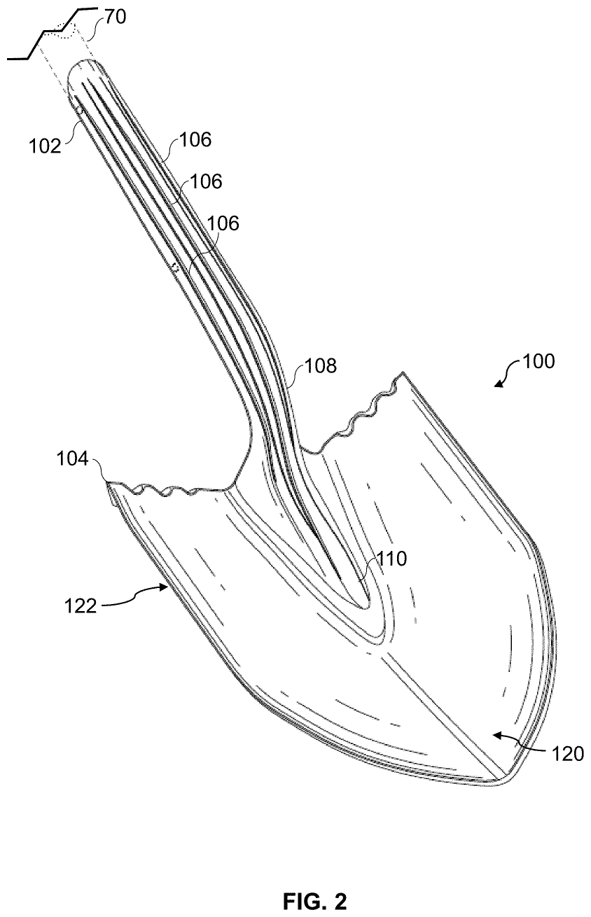

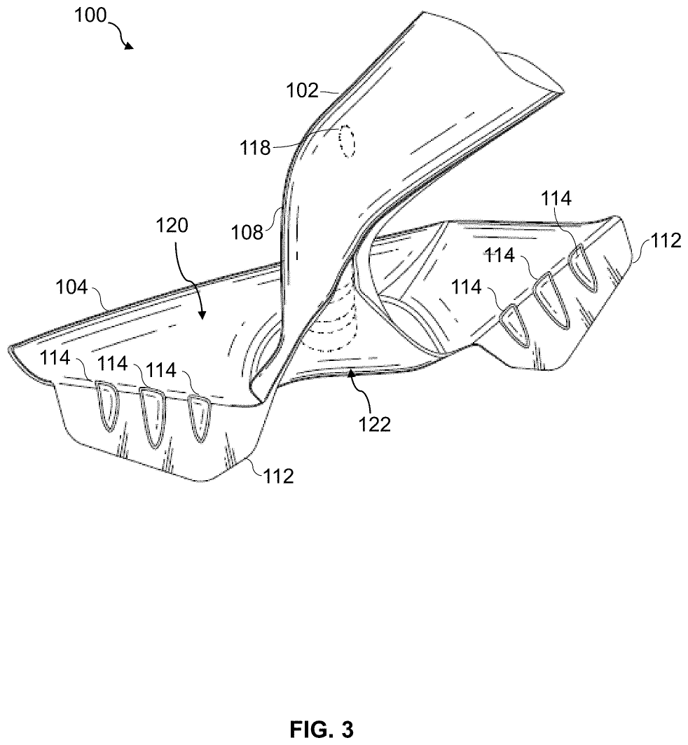

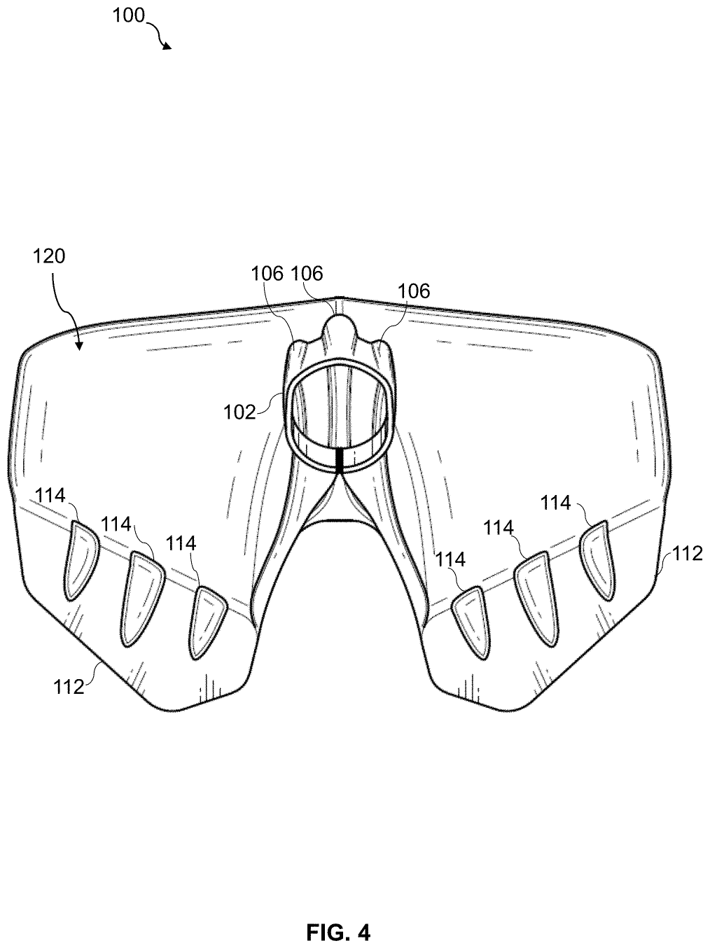

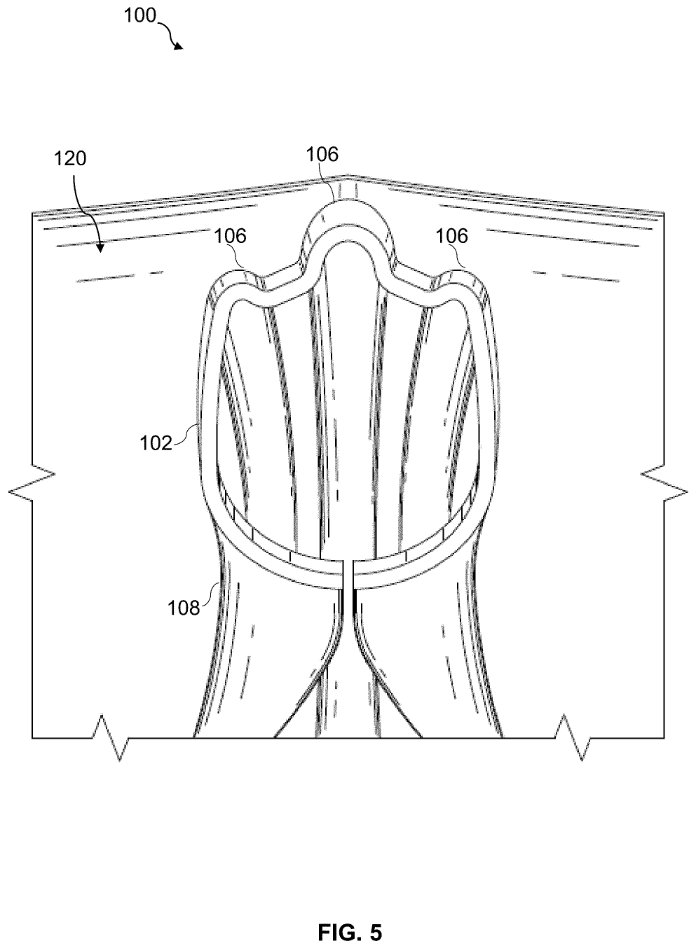

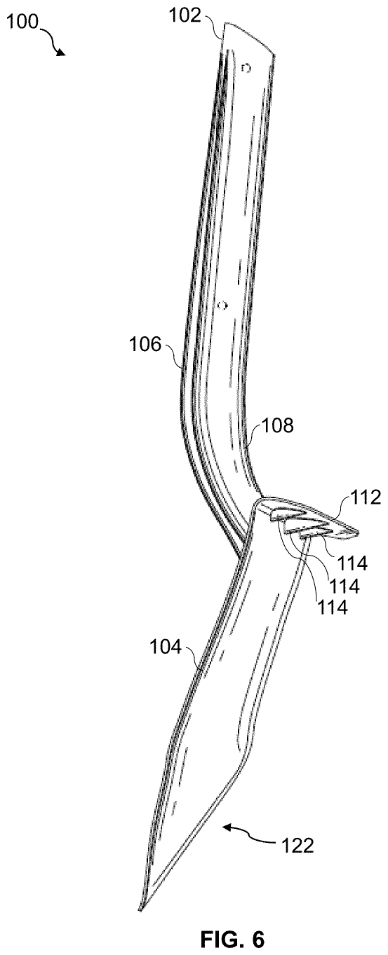

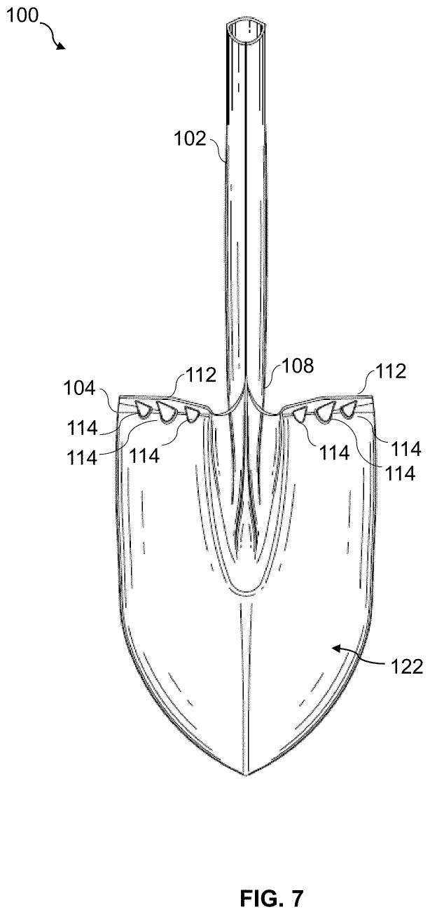

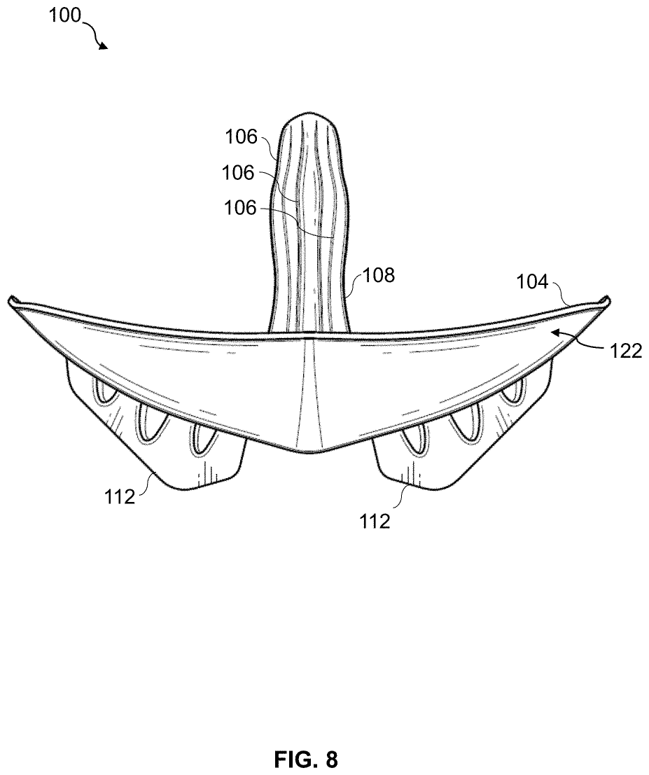

The shovel 50 further comprises a shovel head 100, in accordance with embodiments of the present disclosure. FIG. 2 illustrates a front perspective view of the shovel head 100 and FIG. 3 illustrates a top-down view of the shovel head 100. The shovel head is typically made from sheet steel but can be made of any suitable material; for example, hard plastic or glass-reinforced plastic (ex., fibreglass). FIG. 4 illustrates a top-down perspective view of the shovel head 100. FIG. 5 illustrates a perspective partial cutaway view along the shaft of the shovel head 100. FIG. 6 illustrates a side elevation view of the shovel head 100. FIG. 7 illustrates a rear elevation view of the shovel head 100. FIG. 8 illustrates a bottom-up perspective view of the shovel head 100.

The shovel head 100 includes a socket 102 having a tubular end with an inner diameter dimensioned to receive the shaft 70 therein. The shaft 70 can be affixed to the socket 102 using any suitable approach; for example, a retaining screw 118 or rivet. A shovel blade 104 of the shovel head 100 is connected to the socket 102 on the end opposite the tubular end. In most cases, the socket 102 transitions into a neck portion 108 which is joined to the blade 104 at a frog portion 110. The socket 102 and the shovel blade 104 can be manufactured out of one-piece or can comprise separate pieces affixed to each other. The shovel blade 104 illustrated in FIG. 1 has a rounded-triangular shape, but any suitable shape can be used.

In an embodiment, the shovel head 100 includes one or more ribs 106 (or folds) formed out of the socket 102 that run parallel, or approximately parallel, to the length of the socket 102. In this example, there are three such ribs 106; however any suitable number of ribs 106 can be used. In this case, the ribs 106 are located on the front of the socket 102; however, the ribs 106 can be located on any side, or more than one side, of the socket 102.

In an embodiment, the structural ribs 106 generally begin at or near the top of the socket 102 and extend down through the neck 108 of the shovel head 100 and recede into or around the frog 110 (where the socket 102 joins the blade 104). Advantageously, the ribs 106 provide a significant strength advantage without the need to use a thicker material gauge or additional components. The structural ribs 106 reduce permanent deformation of the socket 102 when under pulling forces, and thus withstands greater force without bending. In some cases, this added structural strength can allow for cheaper and potentially weaker materials on the socket 102.

The present inventors conducted example experiments to determine the strength advantages of the ribs 106 in comparison to typical shovel designs. When pulling down in a prying motion with the blade locked in place, a typical failure is seen whereby the handle snaps at the top of the socket. A conventional shovel would thus fail under more duress at the neck of the socket. A stronger conventional shovel will typically fail when the front tip of the frog breaks. One such stronger conventional shovel was tested to fail in the range of 240-290 lbs of force. In contrast, a shovel head 100 in accordance with the present embodiments was tested to fail at around 350 lbs of force, significantly more than the other shovel.

The shovel blade 104 includes a front surface 120 and a rear surface 122 on opposing sides of the blade 104. The front surface 120 is generally used for supporting shoveled materials. In many cases, the front surface 120 generally defines a concave curvature for supporting such shoveled materials. Additionally, in typical use, the user pierces the ground with the rear surface 122 generally facing the user and the front surface 120 generally facing away from the user. Once the shovel has sufficiently pierced the ground, the user applies a force at the handle 60 and/or shaft 70 to cause the shovel 50 to pivot approximately at the neck 108. This causes the material in front of the front surface 120 to be lifted away from the ground.

In some cases, the shovel head 100 can include one or two steps for providing a surface for the user to apply downwards force with their foot for piercing the ground. In other cases, the shovel head can include 100 no steps and the user can apply force with their foot to the top of the blade 104.

In an embodiment, as illustrated in FIGS. 1B and 3, the shovel head 100 includes two rearwards extending steps 112 on either side of the frog 110. Rearwards is understood to mean a direction that is generally towards a similar direction as faced by the rear surface; for example, forming a 90° angle with the plane of at least a portion of the rear surface 122 and 270° angle with the plane of at least a portion of the front surface. In other cases, there can be only one step located on top of the blade 104 to one side of the frog 110. In most cases, the rearwards extending steps 112 are formed out of the blade 104; however, in other cases, the rearwards extending steps 112 can be separate pieces that are affixed to the blade 104. In some cases, for added strength and stability, one or more ridges 114, comprising indents, protrusions, or folds, can be formed where the rearwards extending steps 112 meet the blade 104. In the example illustrated in FIGS. 4 and 6, indents on the steps 112 extend from the top-down such that they form ridges when viewed from underneath. These indents/ridges overlap where the steps 112 meet the blade 104 for added structural integrity.

A disadvantage of other shovels that include forwards extending steps is that they comprise a weakness (a kink in the edge of the material) created when folding the steps forward. The present inventors determined through experimentation that when folding the steps backwards, the material follows a more natural path, avoiding the stress and weakness created when folding forward. Further advantageously, with the rearwards extending steps 112, the user is in a more balanced state when applying their weight, easing the process of piercing the ground with the blade 104. A further advantage of the rearwards extending steps 112 is that having the steps on the back side of the shovel head 100 allows the user to place a full boot across both steps 112; allowing for more even pressure across both sides of the shovel head 100 and again allowing for better balance when piercing tough terrain.

While the embodiments described herein generally describe the handle 60, the shaft 70, and the shovel head 100 as separate parts, it understood that some or all of these parts can be formed out of a singular piece.

Although the foregoing has been described with reference to certain specific embodiments, various modifications thereto will be apparent to those skilled in the art without departing from the spirit and scope of the invention as outlined in the appended claims.

1. A shovel head of a shovel, the shovel head affixable to a shaft of the shovel, the shovel head comprising:
an elongated socket for receiving the shaft therein at a receiving end;
a blade connected to the socket opposite the receiving end, the blade having a lifting surface and a rear surface opposing the lifting surface; and
a pair of steps extending rearwards from the top of the blade away from the lifting surface and disposed on opposite sides of the elongated socket such that the socket does not block a space between the rearwards extending steps in a plane defined by the rearwards extending steps.

2. The shovel head of claim 1, wherein there are exactly two steps and each step is located on opposite sides of the connection to the elongated socket.

3. The shovel head of claim 1, wherein the one or two steps are formed out of the blade.

4. The shovel head of claim 1, wherein the one or two steps are affixed to the blade.

5. The shovel head of claim 1, wherein the one or two steps comprise one or more ridges formed out of each respective step.

6. The shovel head of claim 5, wherein the one or more ridges are formed where the respective step meet the blade.

7. The shovel head of claim 6, wherein the one or more ridges are formed out of both the blade and the respective step.

8. A shovel comprising the shovel head of claim 1.
